(19) United States
(12) Patent Application Publication
(10) Pub. No.: US 2007/0190307 A1
(43) Pub. Date: Aug. 16, 2007

(54) FOAMED FLUOROELASTIC GASKET MATERIAL

(76) Inventors: Hongwei Li, Livonia, MI (US); Ayaz A. Sheikh, Farmington Hills, MI (US); Alan Wesley, Dunnellon, FL (US)

Correspondence Address: WOOD, HERRON & EVANS, LLP, 2700 CAREW TOWER, 441 VINE STREET, CINCINNATI, OH, 45202, US

(21) Appl. No.: 11/539,664

(22) Filed: Oct. 9, 2006

Related U.S. Application Data
(60) Provisional application No. 60/725,788, filed on Oct. 12, 2005.

(51) Int. Cl. B32B 3/26; B32B 5/14; B32B 3/00

(52) U.S. Cl. 428/315.7; 428/308.4; 428/315.5; 428/315.9; 428/316.6

(57) ABSTRACT

A metal rubber composite includes a metal layer and a foamed fluoroelastomer layer. The foamed fluoroelastomer layer is a cured FKM elastomer. The FKM elastomer includes expanded thermoplastic beads that cause the FKM to foam. The product is formed by applying the uncured FKM product in combination with the elastomeric beads onto a substrate. Any solvent is removed and the beads are heated to cause them to expand. Subsequently, the elastomer is cured at a higher temperature, causing vulcanization.

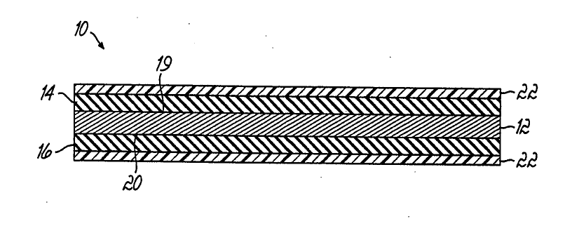

### RELATED APPLICATION

This application is related to and claims the benefit of U.S. Provisional Patent Application Ser. No. 60/725,788, filed on Oct. 12, 2005. The entire disclosure of this application is incorporated herein by reference.

### BACKGROUND OF THE INVENTION

Rubber metal composites are used in a wide variety of different applications, particularly as gaskets in automotive and fluid applications. They are also used as noise, vibration and heat insulators in a variety of applications. In certain situations, it is desirable for the rubber or polymeric material to be foamed. One such highly successful product is a NBR foamed product. This has been used in automotive applications as well as noise, vibration and heat insulation applications.

These foamed NBR products are made by incorporating blowing agents into the rubber formulation. During the cure process the blowing agents expand, foaming the product.

Such NBR foamed composites are useful up to a temperature of about 175° C. Once such temperatures are exceeded, the NBR tends to break down.

### SUMMARY OF THE INVENTION

The present invention is premised on the realization that a high temperature rubber metal composite can be formed having at least one layer of a foamed fluoroelastomer. Preferably, the present invention utilizes a foamed FKM rubber formulation. The FKM product is a terpolymer of tetrafluoroethylene, propylene and vinylidene fluoride. Such a product, when foamed, produces a composite that can withstand in excess of 200° C.

In a preferred embodiment of the present invention, the FKM polymer is foamed using thermoplastic beads incorporating a blowing agent such as isopentene. These provide for very precise control of the foaming reaction and also ensure that the foaming reaction occurs at a temperature below the cure temperature for the FKM polymer and occurs during the cure process of the FKM polymer.

The foamed FKM metal composition of the present invention is useful as automotive gasket material as well as vibration absorbing material, noise dampening material and heat insulation.

The objects and advantages of the present invention will be further appreciated in light of the following detailed descriptions and drawings, in which:

### BRIEF DESCRIPTION OF THE DRAWING

The FIGURE is a cross sectional view of a rubber metal composite according to the present invention.

### DETAILED DESCRIPTION

As shown in the FIGURE, a rubber metal composite 10 includes a central metal layer 12 and either one or two layers of a foamed FKM rubber 14,16 on the two surfaces 19 and 20 of metal layer 12. The outer surfaces of each FKM rubber layer 14 and 16 are preferably coated with a fluorinated polymer release agent 22 such as polytetrafluoroethylene.

FKM polymers are fluororubbers of the polymethylene type that utilize vinylidene fluoride as a comonomer. The FKM polymer for use in the present invention is a terpolymer of tetrafluoroethylene, propylene and vinylidene fluoride. Such polymers are commercially available. One supplier of the FKM polymer is 3M.

The FKM polymer for use in the present invention is applied to a cleaned metal substrate and cured. In particular, the metal substrate can be any metal substrate typically used in gasket material. Such metals include aluminum, stainless steel, and cold rolled steel. The metal will generally be 0.25 to 0.75 mm thick.

To apply the FKM polymer and foam the polymer on the metal substrate, the FKM polymer is dissolved in an appropriate solvent typically a ketone such as methylethyl ketone, or the like. The dissolved polymer is then blended with 15 to 45 phr of carbon black filler, or other acceptable fillers, along with 10 to 20 parts of a metal oxide activator such as MgO or CaO. The preferred activator is magnesium oxide.

Generally, 5-20 phr, preferably 15 phr, blowing agent is blended into the mixture. The preferred blowing agent comprises unexpanded thermoplastic microspheres. One such product is sold by Akzo Nobel. The blowing agent comprises polymeric beads formed from an acrylonitrile methacrylonitrile copolymer filled with isopentene blowing agent. The beads provide void volumes of 90 to 120 microns when expanded and have a blowing temperature of 200° C. plus or minus 50° C.

This blend is then applied to the metal substrate by well known coating techniques onto the metal substrate. Typically a blade coater is used to apply the coating composition onto the metal substrate. The solvent is removed at low temperature, around 100° C., and the coated substrate is heated in hot air ovens, causing the blowing agent to expand at about 200° C. The heating continues curing the FKM polymer.

If two FKM foamed layers are desired, as shown in the FIGURE, the opposite side 20 of the metal surface is coated again, utilizing the same procedure as above. This provides the structure as shown in the FIGURE. If desired, one side of the metal can be coated with a nonfoaming layer of FKM polymer in place of the foamed layer.

The thickness of the expanded FKM layer 12 is preferably about 0.2-0.4 mm with about 0.2 mm preferred.

Subsequent to curing of the product, two layers 22,29 of PTFE are reverse roll coated over the upper and lower surfaces of the FKM layer. Generally, this will form less than 0.1% by weight of the layers 12. Alternately, graphite can be applied to the FKM layers.

A product made according to the above procedure with a thickness of 0.66 mm, with a metal core thickness of 0.24 mm and a rubber coating layer of 0.203 mm per side, was formed (see Table 1). This product was then tested for fluid resistance and mechanical properties. The results of these tests are shown in the following Tables 2 and 3, respectively.

TABLE 1
MATERIAL CONSTRUCTION DETAIL

| ITEM | MATERIAL | THICKNESS, In (mm) |
|---|---|---|
| 1 | Composite | 0.026 nominal (0.66) |
| 2 | Metal Core Nominal | 0.010 nominal (0.254 |
| 3 | Rubber Coating Nominal | 0.0080 nominal (0.203) |
| | | (per side) |

TABLE 2
FLUID RESISTANCE

| ITEM | PROPERTY/PROCEDURE | | SPECIFICATION |
|---|---|---|---|
| 1 | Rubber/Metal Bond | MEK Resistance, WTM-118 | No loss of bond |
| | Integrity | Coolant Resistance, WTM-122 | No loss of bond |
| | | 50/50 Water/Coolant at boiling for 200 Hrs. | |
| 2 | IRM 903 Oil | % Weight Change, max., ASTM F-146 | 10 |
| | | At 300° F. (150° C.) for 5 Hrs. | |
| | | % Thickness Change, max., ASTM F-146 | 15 |
| | | At 300° F. (150° C.) for 5 Hrs. | |
| 3 | Automatic Transmission | % Weight Change, max., ASTM F-146 | 15 |
| | Fluid | At 300° F. (150° C.) for 100 Hrs. | |
| | | Thickness Change, max., ASTM F-146 | −15 |
| | | At 300° F. (150° C.) for 100 Hrs. | |

TABLE 3
MECHANICAL PROPERTIES

| ITEM | PROPERTY/PROCEDURE | | SPECIFICATION |
|---|---|---|---|
| 1 | Maximum Creep Relaxation, ASTM F-38 | | 50 |
| | At 212° F. (100° C.) | | |
| 2 | Compression and Recovery, ASTM F-36 | % Compressibility, min. | 20 |
| | 400 PSI, 5 pound preload, 1.129″ diameter | % Recovery, min. | 50 |
| | indenter; room temperature or after heat | (See explanation; Gasket | |
| | aging at 212° F. (100° C.) for 5 Hrs. | Manual, Section 2.70) | |

Based on the above, the Composite 10 is suitable for use in high temperature environments as gaskets that will contact various fluids, such as engine coolants, oils and transmission fluids. This product is stable at temperatures greater then 200° C. and exhibits a uniform surface structure, as required for gasket applications. Further, the composite 10 can be used as a noise or vibration dampener. It can also be stamped to conform to various shapes, if desired.

Further, the use of the thermoplastic beads incorporating the blowing agent greatly facilitates manufacture of the blown FKM layer with a uniform surface. This, in turn, allows the use of this product in sealing applications.

This has been a description of the present invention along with the preferred method of practicing the present invention. However, the invention itself should only be defined by the appended claims.

What is claimed is:

1. A rubber metal composite material comprising a metal layer having a first and second surface and a first polymeric layer on said first surface, said first polymeric layer comprising a foamed FKM fluoroelastomer.

2. The composite claimed in claim 1 wherein said foamed FKM elastomer comprises a vulcanized FKM polymer in combination with expanded thermoplastic beads.

3. The composite claimed in claim 1 further comprising at least about 15 to about 45 percent reinforcing filler.

4. The composite claimed in claim 1 further comprising an exterior layer of polytetrafluoroethylene.

5. The composite claimed in claim 1 further comprising foam cells of from 90 to 120 microns.

6. The composite claimed in claim 1 wherein said foamed FKM elastomer layer is from 0.2 to 0.4 mm thick.

7. The composite claimed in claim 1 having a second polymeric layer comprising a foamed FKM polymer on a second surface of said metal layer.

8. The composite claimed in claim 1 wherein said metal is selected from the group consisting of steel, stainless steel and aluminum.
